(19) United States
(12) Patent Application Publication
(10) Pub. No.: US 2018/0354206 A1
(43) Pub. Date: Dec. 13, 2018

(54) MOBILE CURING SYSTEM USING SUPERHEATED AIR

(71) Applicant: Infrastructure Technologies, LLC, Fontana, CA (US)

(72) Inventors: JOSEPH ROSEMONT, Brainerd, MN (US); JOSEPH TAYLOR, Brainerd, MN (US)

(21) Appl. No.: 16/001,204

(22) Filed: Jun. 6, 2018

Related U.S. Application Data
(60) Provisional application No. 62/516,737, filed on Jun. 8, 2017.

(51) Int. Cl. B29C 70/44; B29C 70/54; F16L 55/165

(52) U.S. Cl. CPC B29C 70/44; B29L 2023/22; F16L 55/1654; B29C 70/54

(57) ABSTRACT

A curing system for Cured-In-Place-Pipe includes a generator, low pressure high volume blower, heater, upstream sensor and control system housed within a vehicle for mobilization from job site to job site. In use a technician inserts CIPP into a pipe requiring repair, and inputs project specifications such as diameter of CIPP, thickness of CIPP and length of host pipe into the curing system's control system. The technician connects the curing system to the upstream end of the CIPP and initiates the curing process, including the steps of evacuation of ambient air from lining system; pressurizing lining system; superheating lining system; evacuation of superheated air; and relieving pressure after liner has cooled down. During the process, an upstream sensor and a downstream sensor measure parameters such as pressure and temperature and send this data to a control system. The control system includes algorithms that guide the process by adjusting specific parameters such as flow rate, temperature, exhaust rate, and duration, based on upstream and downstream sensor data and differentials there between.

### CROSS-REFERENCE TO RELATED APPLICATIONS

This application claims the benefit of U.S. Provisional Application 62/516,737, filed on Jun. 8, 2017, which is hereby incorporated by reference in its entirety.

### BACKGROUND OF THE INVENTION

The present invention relates to superheated air systems, and more specifically, to a mobile curing system used in the installation of low pressure Cured In Place Pipe (“CIPP”) systems.

The nation's infrastructure such as roads, bridges, and underwater pipes is aging. Many urban areas have underground pipes that have been around for more than a century, and much of the nation's infrastructure was built in the post-World War II era, which puts these systems at 50 or more years old. The emphasis since the infrastructure building boom has generally been on expansion, not replacement and upgrade. Given the age and lack of upkeep, it is not surprising that the infrastructure is often critically deteriorated. This is particularly true for underground pipes, such as water, sewage and gas lines which are difficult to inspect and whose deterioration is difficult to ascertain. Unfortunately, catastrophic pipe failure is often the first warning of the deteriorating condition of a pipe system.

Traditional methods of replacing a pipe and/or pipe sections require digging a trench to access the pipe, removal of the old pipe, putting in new pipe, and tying new pipe into existing structures. This is cumbersome and expensive. More recently, trenchless pipe repair technology has developed. These systems are advantageous insofar as they don't require extensive digging. One trenchless system is the Cured In Place Pipe (“CIPP”). An example of this comprises a fabric tube impregnated with a resin, with an empty bladder within the tube, all wrapped within a plastic sheet. In use this assembly is inserted into an existing pipe, and the bladder is filled with water. The filling bladder expands the resin-impregnated tube to fit the shape of the existing pipe. Pressure is held until the tube is solidified, typically by heating the water, or introducing a mixture of air and steam into the bladder, and a new pipe is created on the inside of the old pipe. In other variations, curing is facilitated by UV light.

While CIPP is an improvement over traditional pipe repair methods, there are still issues. Problems include less than ideal strength and corrosive resistance properties, high product weight, and short shelf life. Also, standard CIPP liner systems typically require unacceptably long cure times.

More recently, improvements in CIPP technology have given rise to a system incorporating thermoplastic with a melt/flow point of approximately 300-342° F. at approximately 5-15 psi, a cure point of approximately 330-370° F. at ambient pressure, and bonding point of approximately 372-412° F. at approximately 5-25 psi. This technology is described in U.S. Provisional Application 62/357,796, filed on Jul. 1, 2016, which is hereby incorporated by reference in its entirety, and U.S. patent application Ser. No. 15/614,852 filed on Jun. 6, 2017, which published on Jan. 4, 18 as publication US-2018-0003332-A1, and issued on as U.S. patent entitled CURED IN PLACE PIPE SYSTEM HAVING INTEGRATED THERMOPLASTIC WITH IMPROVED MELT-FLOW CHARACTERISTICS, which is also hereby incorporated by reference in its entirety. This new high temperature, low pressure curing CIPP technology overcomes the issues associated with earlier CIPP technology, and in particular the problems of pressurizing disintegrated pipes.

High temperature, low pressure curing CIPP technology, however, requires superheating air to 400° F. and beyond, which presents a new set of challenges. Superheating air requires specialized and cumbersome heating equipment, has very high energy demands, is loud, and must be precisely controlled. The hot air must be delivered according to a specific protocol with respect to parameters including ramp up time, pressure, and duration. Incorrectly superheating a CIPP system can destroy the CIPP system by overcuring where the superheated air enters the system, create catastrophic failure of the existing pipe system, damage the surrounding area, and/or injure or kill nearby workers.

As can be seen, there is a need for a system of superheating air for use in curing CIPP. It is desirable that this system is mobile, self-contained, sound insulated, cures relatively quickly, and can be controlled using a user friendly interface.

### SUMMARY OF THE INVENTION

The curing system of the present invention includes a generator, low pressure high volume blower, heater, upstream sensor and control system that are housed within a vehicle such as a utility truck body, for mobilization from job site to job site. The curing system is particularly well configured for use with CIPP systems having thermoplastic with a melt/flow point of approximately 300-342° F. at approximately 5-15 psi, a cure point of approximately 330-370° F. at ambient pressure, and bonding point of approximately 372-412° F. at approximately 5-25 psi.

In use a technician inserts CIPP into a pipe requiring repair, and inputs project specifications into the curing system's control system. Examples of project specifications include diameter of CIPP, thickness of CIPP and heat conductivity of environment adjacent to pipe, and length of host pipe. The technician connects the curing system of the present invention to the upstream end of the CIPP and initiates the curing process, including the steps of evacuation of ambient air from lining system; pressurizing lining system; superheating lining system; evacuation of superheated air; and relieving pressure after liner has cooled down.

During the process, an upstream sensor and a downstream sensor measure parameters such as pressure and temperature and send this data to a control system. The control system includes algorithms that guide the process by adjusting specific parameters such as flow rate, temperature, exhaust rate, and duration, based on upstream and downstream sensor data and differentials there between.

These and other aspects of the present inventions will become apparent to those skilled in the art after a reading of the following description of the preferred embodiment when considered with the drawings.

### BRIEF DESCRIPTION OF THE DRAWINGS

FIG. 1 depicts a curing system in use with CIPP showing major components of curing system;

FIG. 2 depicts a curing system in use with CIPP showing major components of CIPP system;

FIG. 3 depicts major components of a representative lining system;

FIG. 4 depicts a return system bringing air back to curing system;

FIG. 5 depicts an exploded view of an end cap; and

FIG. 6 depicts a lining system slipped secured over the end of an end cap using ratcheting straps.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The following structure numbers shall apply to the following structures among the various FIGS.:

10—Curing system;

15—Truck;

17—Enclosure;

20—Generator;

30—Blower;

40—Heater

41—Air;

42—Heater intake;

44—Heater output;

45—Hot air inlet;

46—Pressure feedback outlet;

47—Pressure feedback return;

48—Hot air outlet;

50—Control system;

52—Display;

60—Lining system;

62—End cap;

63—Film;

64—Tubular substrate;

66—Bladder;

67—Double wall;

68—Ratcheting strap;

69—Retaining ridge;

70—Pipe;

72—Compromised portion;

74—Access;

75—Exhaust assembly;

76—Outlet;

77—Gauge;

78—Upstream sensor;

79—Downstream sensor;

80—Air duct;

82—Perforations;

84—Channel;

87—Return; and

90—Ground.

Broadly, the curing system of the present invention includes a generator, low pressure high volume blower, heater, upstream sensor and control system that are housed within a vehicle such as a utility truck body, for mobilization from job site to job site.

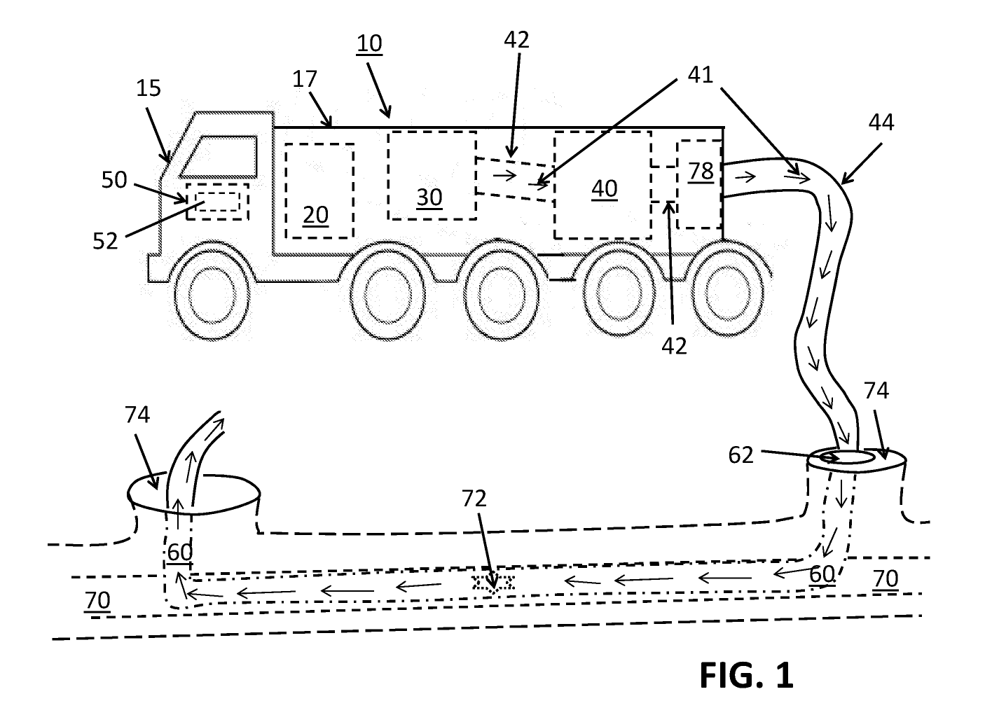

Referring to FIG. 1, curing system 10 includes truck 15 preferably including enclosure 17. It is preferred that the enclosure provides sound insulation. The major components of the system include generator 20, blower 30, heater 40, upstream sensor 78 and control system 50. Generator 20 provides power to blower 30, to heater 40, to upstream sensor 78, and to control system 50 via power connections. The preferred generator is QSB C110 with approximately 110 kW of power, from the Cummins Onan Corporation of Columbus, IN.

Downstream from generator 20 is blower 30 which moves air 41 at a rate of approximately 0-280 cfm and a pressure of approximately 7-12 psi through heater intake 42 which is preferably a 4″-6″ duct. The preferred blower is DTLF 2.400 from Becker Pumps Corp. of Cuyahoga Falls, Ohio.

Air 41 travels through heater intake 42 to heater 40, which is capable of superheating the air to temperatures of approximately 400-470° F. The preferred heater is an inline duct heater from Osram Sylvania of Wilmington, Mass. Air leaving heater enters upstream sensor 78 which is configured to measure parameters such as heat, pressure, velocity, and so forth. After passing through sensor, air exits the truck via heater output 44, which is also preferably a 4″ duct. It should be understood that air passing from heater intake 42 through heater 40 and out to heater output 44 can pass through without being heated. By way of example, a specific CIPP system protocol may require inflation of bladder 66 using ambient temperature air until a desired pressure is reached, and then switching on heater 40 to deliver superheated air 41 to induce curing. Air 41 exits curing system 10 through heater output 44 and enters lining system 60, for example CIPP, at end cap 62.

Control system 50 includes display 52, and facilitates control, automation and monitoring of the system. It is depicted in FIG. 1 as being in the cab of the truck where an operator can comfortably operate it, but the control system can be located in a variety of places, including a portable rack as is known in the industry. Control system 50 allows an operator to control parameters such as inflation rate of bladder, flow rate of blower, ramp time, and holding temperature of heater, and preferably allows an operator to automate the curing system by entering and/or selecting protocols with specific parameters such as inflation rate of bladder, flow rate of blower, end point pressure of bladder, temperature, and duration of superheated air. Specific conditions at a site would determine protocol parameters. For example, a CIPP having a large diameter would require a greater flow rate of superheated air for curing versus a CIPP having a smaller diameter. Control system 50 also allows an operator to monitor curing system 10 by recording and/or displaying real time measurements such as confirmation that components are powered up; temperature, pressure, and duration of a specific condition such as blowing superheated air; and recording a curing process for onboard database storage. Readings from upstream sensor 78 and downstream sensor 79 provide data for operator and/or algorithm controlled protocol adjustments. Control system 50 is connected to generator 20, blower 30 and heater 40 by control system connections. The preferred control system 50 includes an Omron NS15NS12NS10NS8 HMI Series or Omron NA Series from Omron Industrial Automation of Hoffman Estates, Ill.

An example of a protocol in accordance with a method of the present invention is directed to a lining system within an approximately 18″ pipe that is approximately 200 linear feet in length. The bladder inflates with air from the curing system at a rate of approximately 20 mbar/min (0.29 psi/min) which gives 100 mbar (1.5 psi) in 5 minutes to allow the layers of the liner to slip and expand to the shape of the host pipe. After the initial inflation point is reached, the temperature is increased to approximately 200° F. and inflation rate is increased to approximately 50 mbar/min (0.73 psi/min) and pressure is checked and held every five minutes to ensure that the liner is holding pressure. This process is repeated until approximately 690 mbar (10 psi) internal pressure is reached. Once internal pressure has been achieved the temperature is ramped up to approximately 400° F. to approximately 470° F. Thermocouple sensors placed in between the liner and host pipe monitor the heat transfer rate and temperature target. Data from upstream sensor 78 and downstream sensor 79 also preferably helps guide the process. Once the melting process has had sufficient time, the heat is shut off immediately to prevent over melting the liner. The pressure is maintained at approximately 690 mbar (10 psi) until the liner temperature has cooled down to approximately 100° F. or lower. After the liner has cooled down, pressure is relieved and the ends of the liner are cut in such a way to reinstate the pipe back into service.

This protocol may be followed for other repair sites with pipes and lining systems having different lengths and diameters, although the inflation rates and final internal pressures will increase as the internal pressure increases.

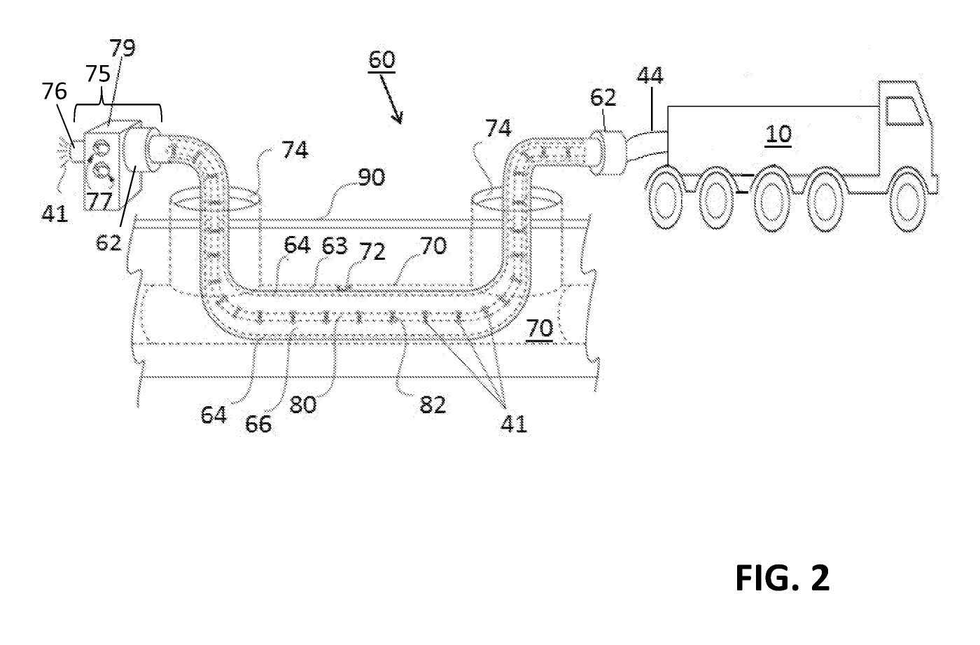

Referring to FIG. 2, air exits curing system 10 through heater output 44 and enters lining system 60 at end cap 62. The flow and temperature of this air is controlled to cure the thermoplastic component of tubular substrate 64. Most protocols include five major steps: evacuation of ambient air from lining system; pressurizing lining system; superheating lining system; evacuation of superheated air; and relieving pressure after liner has cooled down. Air leaving lining system preferably passes through a second (downstream) end cap 62 near immediately before downstream sensor 79.

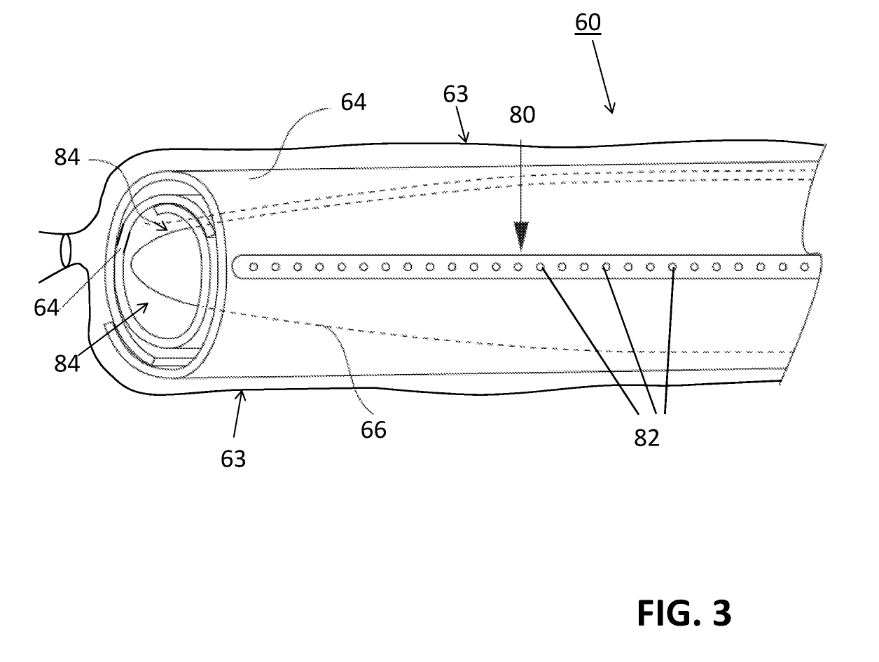

Evacuation of ambient air is preferably performed by pumping warmed air into lining system 60. Removing ambient air creates a faster rate of heat transfer. In this initial step warmed air, preferably approximately 150-250° F., and most preferably approximately 200° F., is pumped into channel 84 of lining system 60. It should be understood that at this step bladder 66 is not yet fully inflated, unlike the depiction in FIG. 3.

After evacuation of ambient air, bladder 66 is inflated with warmed air, again preferably approximately 150-250° F., and most preferably approximately 200° F. Inflation of bladder expands tubular substrate 64 to fit snugly within pipe 70, and blocks compromised portion 72. Bladder inflation continues until the desired pressure is achieved, preferably approximately 5-15 psi.

A preferred embodiment, depicted in FIG. 2, includes upstream sensor 78 and downstream sensor 79. Downstream sensor 79 is preferably integrated with exhaust assembly 75 which also includes outlet 76. These sensors measure parameters such as pressure and temperature and send these data via control system connections to control system 50. Optionally, data may also be displayed on gauges 77 and/or display 52. The control system includes algorithms that guide the process by adjusting specific parameters such as flow rate, temperature, exhaust rate, duration, based on upstream and downstream sensor data and differentials there between. By way of example, if a specific protocol requires air at 325° F. and 10 psi for 10 minutes then depressurization, the control system will start the 10 minutes when downstream sensor 79 reads 325° F. and 10 psi, maintain these conditions for 10 minutes, then depressurize by opening outlet 76.

Once lining system 60 is positioned and pressurized, it is ready for curing with superheated air. In a preferred method, superheated air, preferably approximately 400-470° F., is blown into air duct 80 which runs substantially the length of lining system 60. As shown in FIG. 3, air duct 80 includes a plurality of perforations 82, thereby delivering superheated air to the entire length of liner system 60 substantially uniformly.

In an alternative method an air duct isn't used, and superheated air enters at end cap 62 into bladder 66. This embodiment has the disadvantage of the curing process starting at end of lining system nearest the end cap, versus substantially simultaneous curing that is achieved using an air duct with perforations.

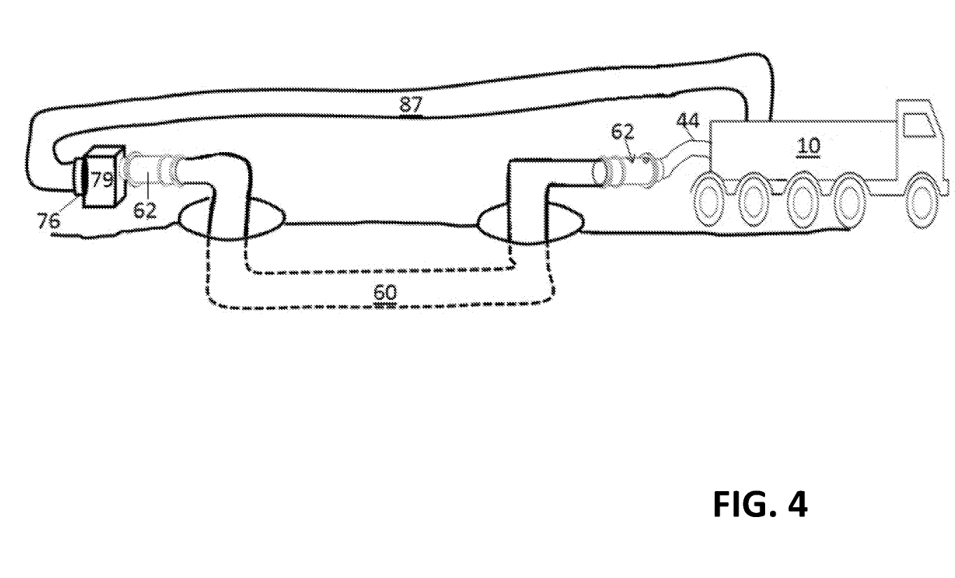

In an alternative embodiment, return 87 is connected at outlet 76 and returns superheated air to inline heater 40. This is depicted in FIG. 4.

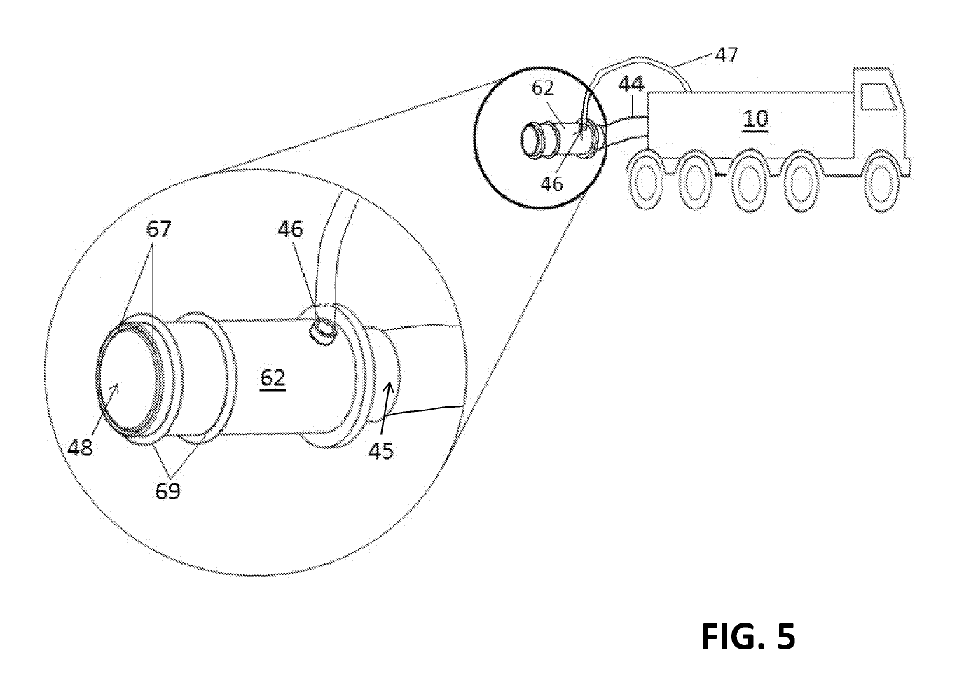

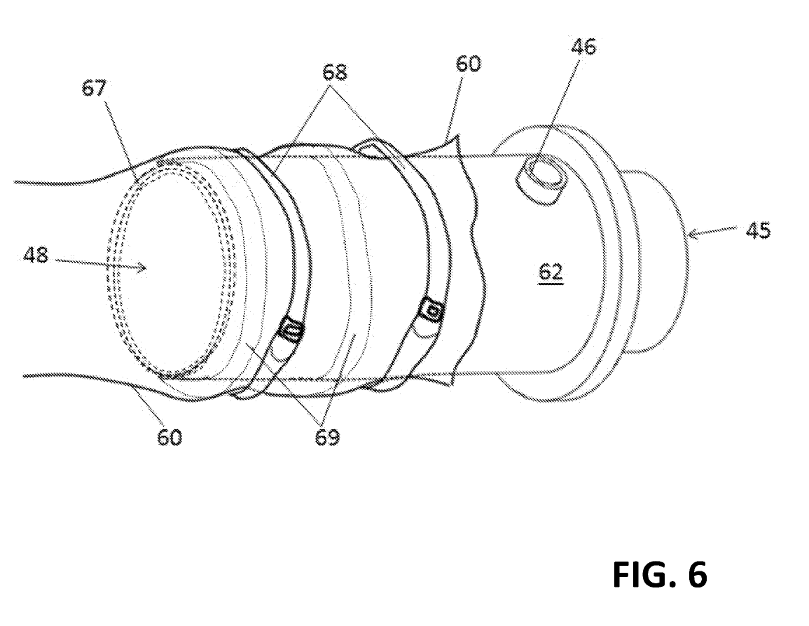

In a preferred embodiment, depicted in FIG. 5, end cap 62 includes double walls 67 which protect lining system 60 from superheated air. This is to prevent undesirable curing of lining system to end cap 62. In use, lining system 60 is slipped over end of end cap and secured using ratcheting straps 68. Retaining ridges 69 on end cap 62 prevent lining system 60 from slipping off end cap, especially during inflation. This is shown best in FIG. 6. Downstream end cap 62 is preferably present immediately before downstream sensor 79, as shown in

FIG. 2. Hot air inlet 45 can be a variety of diameters, with 3″ generally being suitable for 6″-8″ liners, and 4″ and up for larger endcaps typically used with larger diameter liners.

End cap 62 also preferably includes pressure feedback outlet 46, which is coupled to a pressure transducer on the truck (not shown), which gives internal pressure data to the control system for interpretation by the operator and/or automated program. In a preferred embodiment pressure feedback outlet 46 and pressure transducer provide pressure data to control system 50. Also pressure feedback outlet 46 and pressure feedback return 47 may function as a pressure release system, particularly as a safety relief measure or for automatic shutdown of the system. Likewise, downstream end cap 62 preferably includes pressure feedback outlet 46, which is coupled to pressure transducer on downstream sensor 79, and provides pressure data to control system, operator and/or automated system.

In use a technician inserts CIPP into a pipe requiring repair, and inputs project specifications such as diameter of CIPP and thickness of CIPP into control system 50. The technician connects the curing system of the present invention to the upstream end of the CIPP and initiates the curing process. The curing process generally includes the steps of evacuation of ambient air from lining system; pressurizing lining system; superheating lining system; evacuation of superheated air; and relieving pressure after liner has cooled down. Upstream sensor 78 and a downstream sensor 79 take real time measurements and send these data to control system 50. The control system includes algorithms that guide the process by adjusting specific parameters such as flow rate, temperature, and exhaust rate based on upstream and downstream sensor data and differentials there between.

Specifications of certain structures and components of the present invention have been established in the process of developing and perfecting prototypes and working models. These specifications are set forth for purposes of describing an embodiment, and setting forth the best mode, but should not be construed as teaching the only possible embodiment. Rather, modifications may be made without departing from the spirit and scope of the invention as set forth in the following claims. It should be understood that all specifications, unless otherwise stated or contrary to common sense, are +/−10%, and that ranges of values set forth inherently include those values, as well as all increments between.

I claim:

1. A curing system for Cured-In-Place-Pipe including;
A. A vehicle;
B. A generator mounted on said vehicle;
C. A blower connected to said generator and mounted on said vehicle; and
D. A heater connected to said blower and mounted on said vehicle, said heater configured to superheat air to a temperature of approximately 400° F.

2. The curing system of claim 1 further including a control system mounted on said vehicle, said control system communicatively coupled with, and configured to influence the function of, said generator, said blower, and said heater.

3. The curing system of claim 2 further including an upstream sensor positioned to receive said air from said heater, said upstream sensor communicatively coupled with said control system.

4. The curing system of claim 3 wherein said upstream sensor is configured to measure pressure and temperature.

5. The curing system of claim 3 further including a downstream sensor communicatively coupled with said control system, said downstream sensor configured to measure pressure and temperature.

6. A Cured-In-Place-Pipe system including;
A. A vehicle-mounted curing assembly;
B. A segment of Cured-In-Place-Pipe connected to said curing assembly;
C. An upstream sensor configured to measure air entering said segment of Cured-In-Place-Pipe; and
D. A control system communicatively coupled with said upstream sensor.

7. The Cured-In-Place-Pipe system of claim 6 wherein said vehicle-mounted curing assembly includes a heater configured to superheat air to a temperature of approximately 400° F.

8. The Cured-In-Place-Pipe system of claim 6 wherein said vehicle-mounted curing assembly includes a generator having at least approximately 110 kW of power.

9. The Cured-In-Place-Pipe system of claim 6 wherein said vehicle-mounted curing assembly includes a blower capable of moving air at maximum rate of approximately 280 cfm.

10. The Cured-In-Place-Pipe system of claim 6 further including an endcap positioned between said vehicle-mounted curing assembly and said segment of Cured-In-Place-Pipe.

11. The Cured-In-Place-Pipe system of claim 10 wherein said endcap has a double wall.

12. The Cured-In-Place-Pipe system of claim 6 further including a downstream sensor configured to measure air exiting said segment of Cured-In-Place-Pipe.

13. The Cured-In-Place-Pipe system of claim 12 wherein said downstream sensor is communicatively coupled with said control system.

14. A method of curing Cured-In-Place-Pipe including the acts of:
A. Inserting uncured Cured-In-Place-Pipe into a pipe requiring reinforcement;
B. Connecting said uncured Cured-In-Place-Pipe to a vehicle-mounted curing system having a generator, blower and heater;
C. Turning on said generator, blower and heater;
D. Blowing superheated air into said Cured-In-Place-Pipe; and
E. Allowing said Cured-In-Place-Pipe to cure.

15. The method of claim 14 further including the acts of measuring pressure of air entering said Cured-In-Place-Pipe with an upstream sensor, and sending upstream pressure data to a control system.

16. The method of claim 15 further including the acts of measuring pressure of air exiting said Cured-In-Place-Pipe with a downstream sensor, and sending downstream pressure data to said control system.

17. The method of claim 15 further including the act of turning off said blower in response to upstream pressure data and downstream pressure data.
